(19) United States
(12) Patent Application Publication
(10) Pub. No.: US 2016/0323517 A1
(43) Pub. Date: Nov. 3, 2016

(54) Method and system for tracking moving trajectory based on human features

(71) Applicant: Protruly Vision Technology Group CO.,LTD, Nanjing (CN)

(72) Inventors: Gang Long, Nanjing (CN); Songwei Lin, Nanjing (CN)

(73) Assignee: Protruly Vision Technology Group CO.,LTD

(21) Appl. No.: 14/886,093

(22) Filed: Oct. 19, 2015

(30) Foreign Application Priority Data
Apr. 29, 2015 (CN) 201510211049.6

(51) Int. Cl. H04N 5/232; H04N 7/18; H04N 5/33; G06T 7/20; G06T 7/00

(52) U.S. Cl. CPC H04N 5/23296; G06T 7/204; G06T 7/0085; G06T 7/2013; H04N 5/33; H04N 7/183; G06T 2207/30241; G06T 2207/10048; G06T 2207/30196; G06T 2207/30232

(57) ABSTRACT

The present invention discloses a method and system for tracking a moving trajectory based on human features. The method comprises: simultaneously capturing images by a zooming CCD camera and an infrared thermal imager, and respectively transmitting the images to an intelligent analysis unit A and an intelligent analysis unit B; extracting and matching blocking features by a human feature identifying module of the intelligent analysis unit A, and detecting a target moving human body by a moving object detecting module; detecting a human boundary by the intelligent analysis unit B; obtaining analysis data in real time by a main control unit, computing the proportion of the size of the target moving human body in the size of the whole image, and a deviation angle and direction of a moving target and an optical axis, and transmitting the same to a cloud terrace control unit; and controlling the horizontal angle of a cloud terrace system, the vertical angle of the cloud terrace system and the focal distance of the zooming CCD camera by the cloud terrace control unit so that the moving target is always in the middle of the visual field of the zooming CCD camera. The present invention is not affected by the factors of weather, illumination, shadows and the like, and has lower probability of missing detection and false detection.

### CROSS-REFERENCE TO RELATED APPLICATIONS

This application is a continuation of, and claims priority to, Chinese Patent Application No. 201510211049.6 with a filing date of Apr. 29, 2015. The content of the aforementioned application, including any intervening amendments thereto, is incorporated herein by reference.

### TECHNICAL FIELD

The present invention relates to the field of intelligent transportation, in particular to a method and system for tracking a moving trajectory based on human features.

### BACKGROUND OF THE PRESENT INVENTION

The tracking of a human moving trajectory integrates advanced technologies of the fields of image collection, detection of moving objects, pattern identification, automatic control and the like, and is mainly applied to intelligent safety monitoring, human-machine interfaces and detailed analysis of human movement. Especially after the United States experiences 911 terrorist attack, the world increasingly pays close attention to the safety problem.

An intelligent safety monitoring system based on perspective analysis not only can efficiently finish a safety guarantee task, but also can greatly save manpower and material resources. Therefore, the research on the tracking of the human moving trajectory has wide application prospect. The tracking of the human moving trajectory mainly relates to the detection of the moving objects, the identification of human features and the tracking of the trajectory. The existing tracking solution only adopts an ordinary CCD camera for performing image collection, the detection of the moving objects and the identification of human features, and is easy to be affected by the factors of weather, illumination, shadows and the like, causing the situation of target loss due to false detection and missing detection.

### SUMMARY OF THE PRESENT INVENTION

The purpose of the present invention is to provide a method and system for tracking a moving trajectory based on human features, and the present invention is not affected by the factors of weather, illumination, shadows and the like, and has lower probability of missing detection and false detection.

To achieve the above purpose, the present invention provides the following technical solution:

A method for tracking a moving trajectory based on human features comprises the following steps:

step 1: an image capturing unit carried on a cloud terrace system comprising a zooming CCD camera and an infrared thermal imager; simultaneously performing image capturing on a monitoring environment by the zooming CCD camera and the infrared thermal imager; transmitting a captured image to an intelligent analysis unit A by the zooming CCD camera; and transmitting a captured image to an intelligent analysis unit B by the infrared thermal imager;

step 2: performing image algorithm analysis on the image captured by the zooming CCD camera through a human feature identifying module carried by the intelligent analysis unit A, and detecting and separating the information of a human dynamic profile, a head, hands and feet, extracting blocking features of image information and building a histogram; contrasting and matching the extracted blocking features with a human feature library by adopting a decision tree classifier; and detecting a target moving human body from the images by a moving object detecting module carried by the intelligent analysis unit A by adopting a method for extracting a moving target in a gray image sequence;

step 3: adopting edge detection in the image captured by the infrared thermal imager through the intelligent analysis unit B, and detecting a human boundary;

step 4: obtaining analysis data in real time by a main control unit from the intelligent analysis unit A and the intelligent analysis unit B, computing the proportion of the size of the target moving human body in the size of the whole image, and a deviation angle and direction of the moving target and an optical axis, and transmitting a horizontal deviation value and a vertical deviation value for deviation from the optical axis, and a size proportion value to a cloud terrace control unit; and

step 5: controlling the horizontal angle of a cloud terrace system, the vertical angle of the cloud terrace system and the focal distance of the zooming CCD camera by the cloud terrace control unit according to the horizontal deviation value, the vertical deviation value and the size proportion value of the moving target so that the moving target is always in the middle of the visual field of the zooming CCD camera, thereby realizing tracking on a human moving trajectory.

A system for tracking a moving trajectory based on human features comprises a zooming CCD camera, an infrared thermal imager, an intelligent analysis unit A, an intelligent analysis unit B, a cloud terrace control unit and a main control unit, wherein the zooming CCD camera captures an image and transmits the image to the intelligent analysis unit A; the infrared thermal imager captures an image and transmits the image to the intelligent analysis unit B; the intelligent analysis unit A and the intelligent analysis unit B are respectively connected with the main control unit; the main control unit is connected with the cloud terrace control unit; and the cloud terrace control unit respectively performs data interaction with the zooming CCD camera and the infrared thermal imager.

As a further solution of the present invention: the cloud terrace control unit controls the zooming CCD camera and the infrared thermal imager to perform 120° rotation in a vertical direction and perform 360° rotation in a horizontal direction; and the cloud terrace control unit also controls the zooming CCD camera to perform a zooming action.

As a further solution of the present invention: the intelligent analysis unit A comprises a human feature identifying module and a moving object detecting module.

Compared with the prior art, the present invention has the beneficial effects: 1. the zooming CCD camera is adopted, so the monitoring and tracking range is wide; 2. the intelligent analysis unit A adopts the method of extracting the moving target in a gray image sequence, and the moving target extracted by the algorithm has small distortion and low false detection rate; and the moving target extracted by the algorithm has small distortion and low false detection rate; 3. a human basic profile and features are obtained through the image analysis of the infrared thermal imager, thereby evading the situation of false detection caused by outside environmental change of weather, illumination, shadows and the like. The present invention has lower probability of generating missing detection and false detection.

### BRIEF DESCRIPTION OF THE DRAWINGS

FIG. 1 is a system structure block diagram of embodiment 1 of the present invention.

### DETAILED DESCRIPTION OF THE PRESENT INVENTION

The technical solution in the embodiment of the present invention will be clearly and completely described below with combination of the embodiment and the drawing of the present invention. Apparently, the described embodiment is merely some but not all of embodiments of the present invention. On the basis of the embodiment in the present invention, all other embodiments obtained by those skilled in the art on the premise of not making any creative effort shall belong to the protection scope of the present invention.

### Embodiment 1

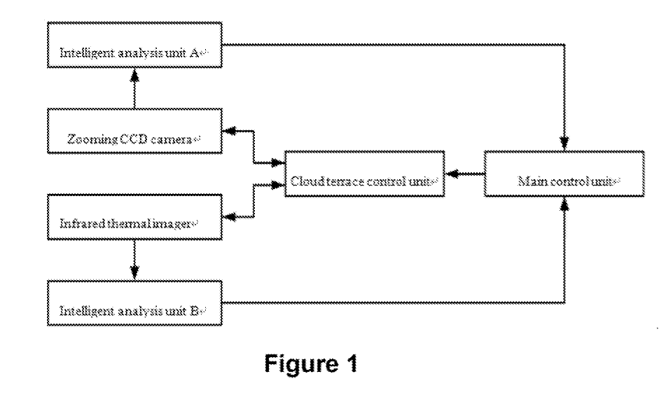

Please with reference to FIG. 1, in the embodiment of the present invention, a system for tracking a moving trajectory based on human features consists of a zooming CCD camera, an infrared thermal imager, an intelligent analysis unit A, an intelligent analysis unit B, a cloud terrace control unit and a main control unit, wherein the zooming CCD camera captures an image and transmits the image to the intelligent analysis unit A; the infrared thermal imager captures an image and transmits the image to the intelligent analysis unit B; the intelligent analysis unit A and the intelligent analysis unit B are respectively connected with the main control unit; the main control unit is connected with the cloud terrace control unit; and the cloud terrace control unit respectively performs data interaction with the zooming CCD camera and the infrared thermal imager.

The intelligent analysis unit A comprises a human feature identifying module and a moving object detecting module.

The cloud terrace control unit can control the zooming CCD camera and the infrared thermal imager to perform 120° rotation in a vertical direction and perform 360° rotation in a horizontal direction, and can control the zooming CCD camera to perform a zooming action.

The zooming CCD camera adopts an advanced 3A technology (automatic focusing (AF), automatic exposure (AE) and automatic white balance (AWB)) to achieve that a clear image can be captured within the entire zooming range of the camera.

The infrared thermal imager uses a photoelectric technology to detect an infrared specific band signal of human heat radiation; the signal is converted into an image and a figure capable of being distinguished by human vision; and the human basic profile and the features can be obtained through the image analysis of the thermal imager, thereby evading the situation of false detection of the intelligent analysis unit A caused by outside environmental change of weather, illumination, shadows and the like.

The intelligent analysis unit B adopts edge detection in the image captured by the infrared thermal imager and detects a human boundary for evading the situation of false detection caused by outside environmental change of weather, illumination, shadows and the like.

A method for tracking a moving trajectory based on human features comprises the following steps:

step 1: an image capturing unit carried on a cloud terrace system comprising a zooming CCD camera and an infrared thermal imager; simultaneously performing image capturing on a monitoring environment by the zooming CCD camera and the infrared thermal imager; transmitting a captured image to an intelligent analysis unit A by the zooming CCD camera; and transmitting a captured image to an intelligent analysis unit B by the infrared thermal imager;

step 2: performing image algorithm analysis on the image captured by the zooming CCD camera through a human feature identifying module carried by the intelligent analysis unit A, and detecting and separating the information of a human dynamic profile, a head, hands and feet, extracting blocking features of image information and building a histogram; contrasting and matching the extracted blocking features with a human feature library by adopting a decision tree classifier; and detecting a target moving human body from the images by a moving object detecting module carried by the intelligent analysis unit A by adopting a method for extracting a moving target in a gray image sequence;

step 3: adopting edge detection in the image captured by the infrared thermal imager through the intelligent analysis unit B, and detecting a human boundary for evading the situation of false detection caused by outside environmental change of weather, illumination, shadows and the like;

step 4: obtaining analysis data in real time by a main control unit from the intelligent analysis unit A and the intelligent analysis unit B, computing the proportion of the size of the target moving human body in the size of the whole image, and a deviation angle and direction of the moving target and an optical axis, and transmitting a horizontal deviation value and a vertical deviation value for deviation from the optical axis, and a size proportion value to a cloud terrace control unit; and

step 5: controlling the horizontal angle of a cloud terrace system, the vertical angle of the cloud terrace system and the focal distance of the zooming CCD camera by the cloud terrace control unit according to the horizontal deviation value, the vertical deviation value and the size proportion value of the moving target; the cloud terrace system having sensitive response and stably adjusting the deflection angle in real time so that the moving target is always in the middle of the visual field of the zooming CCD camera, thereby realizing tracking on a human moving trajectory. The amount of rotation of a cloud terrace is crucial to the tracking of the moving target. If the rotation amplitude of the cloud terrace is excessively large, a tracked moving target may be lost in the visual field; and if the rotation amplitude of the cloud terrace is excessively small, the moving target may be lost because the moving speed of the tracked moving target cannot be caught.

For those skilled in the art, it is apparent that the present invention is not limited to the details of the above-mentioned exemplary embodiment. Moreover, the present invention can be realized in other specific forms without departing from the spirit or basic feature of the present invention. Therefore, in every way, the embodiment shall be regarded to be demonstrative, and non-limiting. The scope of the present invention is defined by the appended claims rather than the above-mentioned illustration. Therefore, the purpose is to embrace all changes within the implication and scope of equivalent essentials fallen into the claims into the present invention.

In addition, it should be appreciated that although the description is depicted according to the embodiment, not every embodiment only contains one independent technical solution. This depicting manner of the description is only for clarity. The description should be regarded as a whole by those skilled in the art, and the technical solution in each embodiment can also be appropriately combined to form other embodiments that can be understood by those skilled in the art.

We claim:

1. A method for tracking a moving trajectory based on human features, characterized by comprising the following steps:
step 1: an image capturing unit carried on a cloud terrace system comprising a zooming CCD camera and an infrared thermal imager; simultaneously performing image capturing on a monitoring environment by the zooming CCD camera and the infrared thermal imager; transmitting a captured image to an intelligent analysis unit A by the zooming CCD camera; and transmitting a captured image to an intelligent analysis unit B by the infrared thermal imager;
step 2: performing image algorithm analysis on the image captured by the zooming CCD camera through a human feature identifying module carried by the intelligent analysis unit A, and detecting and separating the information of a human dynamic profile, a head, hands and feet, extracting blocking features of image information and building a histogram; contrasting and matching the extracted blocking features with a human feature library by adopting a decision tree classifier; and detecting a target moving human body from the images by a moving object detecting module carried by the intelligent analysis unit A by adopting a method for extracting a moving target in a gray image sequence;
step 3: adopting edge detection in the image captured by the infrared thermal imager through the intelligent analysis unit B, and detecting a human boundary;
step 4: obtaining analysis data in real time by a main control unit from the intelligent analysis unit A and the intelligent analysis unit B, computing the proportion of the size of the target moving human body in the size of the whole image, and a deviation angle and direction of the moving target and an optical axis, and transmitting a horizontal deviation value and a vertical deviation value for deviation from the optical axis, and a size proportion value to a cloud terrace control unit; and
step 5: controlling the horizontal angle of a cloud terrace system, the vertical angle of the cloud terrace system and the focal distance of the zooming CCD camera by the cloud terrace control unit according to the horizontal deviation value, the vertical deviation value and the size proportion value of the moving target so that the moving target is always in the middle of the visual field of the zooming CCD camera, thereby realizing tracking on a human moving trajectory.

2. A system for tracking a moving trajectory based on human features, characterized by comprising a zooming CCD camera, an infrared thermal imager, an intelligent analysis unit A, an intelligent analysis unit B, a cloud terrace control unit and a main control unit, wherein the zooming CCD camera captures an image and transmits the image to the intelligent analysis unit A; the infrared thermal imager captures an image and transmits the image to the intelligent analysis unit B; the intelligent analysis unit A and the intelligent analysis unit B are respectively connected with the main control unit; the main control unit is connected with the cloud terrace control unit; and the cloud terrace control unit respectively performs data interaction with the zooming CCD camera and the infrared thermal imager.

3. The system for tracking the moving trajectory based on human features according to claim 2, characterized in that the cloud terrace control unit controls the zooming CCD camera and the infrared thermal imager to perform 120° rotation in a vertical direction and perform 360° rotation in a horizontal direction; and the cloud terrace control unit also controls the zooming CCD camera to perform a zooming action.

4. The system for tracking the moving trajectory based on human features according to claim 2, characterized in that the intelligent analysis unit A comprises a human feature identifying module and a moving object detecting module.
